(19) United States
(12) Patent Application Publication
(10) Pub. No.: US 2017/0109812 A1
(43) Pub. Date: Apr. 20, 2017

(54) TECHNIQUES FOR GENERATING AUTOMOBILE SALES LEADS

(71) Applicant: uQuote, Inc., Danville, CA (US)

(72) Inventors: Roman Dobrik, San Jose, CA (US); Carlos Hidalgo, Sacramento, CA (US); Abraham Mathew, Danville, CA (US); Roy Mathew, Danville, CA (US); Justin Tinker, Loomis, CA (US)

(21) Appl. No.: 15/274,308

(22) Filed: Sep. 23, 2016

Related U.S. Application Data
(60) Provisional application No. 62/222,395, filed on Sep. 23, 2015.

(51) Int. Cl. G06Q 30/06; G06K 7/10

(52) U.S. Cl. CPC G06Q 30/0643; G06K 7/10762; G06K 7/10861; G06Q 30/0623

(57) ABSTRACT

The present disclosure describes methods, systems and computer program products that individually provide an improved lead generating service for automobile dealers.

### RELATED APPLICATIONS

The present application claims the benefit of the filing date of U.S. Provisional Application Ser. No. 62/222,395, filed on Sep. 23, 2015, which is hereby incorporated herein.

### TECHNICAL FIELD

The present disclosure generally relates to data processing systems. More specifically, the present disclosure relates to technical improvements in computing—and specifically, mobile computing systems—that enable generating automobile sales leads.

### BACKGROUND

A variety of online or web-based applications and services exist for the purpose of allowing potential buyers of automobiles to research automobiles prior to making a purchase. In many cases, these applications and services also serve as lead generating services for automobile dealers. However, from an automobile dealer's perspective, these services are flawed for a number of reasons. The following are just some of the many problems associated with existing lead generating services currently in use by automobile dealers.

First, the leads generated by existing services frequently are of poor quality in the sense that the lead may have been generated as a result of a consumer performing preliminary research about an automobile, but not yet ready to make an actual purchase. For instance, an end-user of a web-based automobile research application or service may be performing basic research about a future automobile purchase, and may have no imminent plans to make a purchase. Similarly, the leads received by automobile dealers via such services may not be a good match in terms of what a particular automobile dealer has in inventory, and what the potential customer wants to purchase. With many lead generating services, after receiving a lead, an automobile dealer may be required to manually prepare an appropriate query to search current inventory, based on limited information about a desired vehicle received with the lead. This frequently leads to less than perfect matches, leaving the potential customer in frustration, and ultimately wasting the time of both the dealer and the customer. Finally, in many instances, the leads received by automobile dealers using existing lead generation services may be for potential customers who are not residing or located in the same proximity as the automobile dealer, thereby decreasing the likelihood that a potential customer would travel to the automobile dealer's location to conclude a transaction. In many instances, the location of the potential customer may not even be revealed to the automobile dealer.

### DESCRIPTION OF THE DRAWINGS

Some embodiments are illustrated by way of example and not limitation in the FIG's. of the accompanying drawings, in which:

FIG. 1 is a block diagram illustrating a computer network environment in which embodiments of the present invention might be deployed;

FIG. 2 is a multi-component flow diagram showing the various processing steps or operations performed by the various components, consistent with some embodiments;

FIGS. 3-A and 3-B are diagrams illustrating an example of a user interface and providing an example of how an end-user scans a code associated with an automobile, using a mobile computing device, consistent with some embodiments of the invention;

FIGS. 4-7 are user interface diagrams showing examples of a user interface of a mobile application, consistent with some embodiments; and

FIG. 8 is a block diagram of a machine in the form of a computing device within which a set of instructions, for causing the machine to perform any one or more of the methodologies discussed herein, may be executed.

### DETAILED DESCRIPTION

The present disclosure describes methods, systems and computer program products that individually provide a lead generating service for automobile dealers. With various embodiments of the present invention, end-users (e.g., potential automobile purchasers) can obtain information about an automobile of interest, while automobile dealers can obtain information about potential customers and the automobiles those customers are interested in purchasing. In the following description, for purposes of explanation, numerous specific details are set forth in order to provide a thorough understanding of the various aspects of different embodiments of the present invention. However, it will be evident to one skilled in the art that the present invention may be practiced without all of the specific details.

Consistent with some embodiments of the present invention, a potential automobile purchaser (hereinafter referred to simply as an end-user), downloads and installs a mobile application on his or her mobile computing device (e.g., mobile phone, or tablet). With the mobile application, using a camera or other imaging sensor of the mobile computing device, the end-user can scan (or, in some instances, manually input) a code that is affixed to or otherwise associated with an automobile—particularly a new automobile located on an automobile dealer's lot. Such a code, for instance, may be presented on what is commonly known as the sticker that is typically attached to and presented in a window of a new automobile on a dealer's lot. The scanned code is then transmitted wirelessly over a communications network, with geo-location information representing the exact location where the code was scanned, to a cloud-based lead generating application. At the lead generating application, the scanned code and geo-location information are processed and used to obtain information about the exact make and model of automobile from which the code was scanned. For example, using the scanned code as a key, a database is queried for information (e.g., make, model, year, trim level, colors, etc.) relating to the automobile from which the code was scanned. The obtained information about the automobile is then communicated back to the mobile computing device where it is presented to the end-user, along with information about various automobile dealers who have current inventory potentially matching the desired automobile.

Consistent with some embodiments, the mobile application presents the information about the automobile to the end-user in a manner that allows the end-user to manipulate various data fields, and thereby customize the automobile information to select desired options e.g., trim levels, interior and/or exterior color selections, and various other options). Once the end-user has specified the desired selections for his or her automobile of interest, the end-user can manipulate the user interface (e.g., by selecting buttons, etc.) to cause the mobile application to communicate a first request to the cloud-based lead generating application or service. Once received at the cloud-based lead generating application or service, the first request may be automatically processed in accordance with various configuration settings and parameters established by the various automobile dealers who are actively participating partners with the operator of the lead generating service. In such a scenario, an automated response with dealer information and dealer inventory information may be communicated back to the end-user.

Once the end-user has received a response to the first request, the end-user can select the particular dealers from which the end-user would like to receive a quote. Accordingly, a second request (a quote request) is generated and communicated to the selected dealers, via the cloud-based lead generating application. The quote request is received at the cloud-based lead generating application and initially processed in accordance with various parameters established by the participating dealers, particularly those selected by the end-user. For example, in some instances, a dealer may specify that quote requests, under certain circumstances, are to be automatically processed such that an automated response is generated by the cloud-based lead generating application and communicated to the end-user. In other instances, a dealer may opt for manual response mode, such that quote requests are automatically forwarded from the lead generating application to a dealer's console application, where the quote request is processed for the purpose of enabling the dealer to generate a customized or personalized response. For example, each participating dealer may have a dealer console application that serves as an interface to the lead generating application or service. Through this dealer console application, the dealer can configure parameters by which automatic responses can be generated. Alternatively, a dealer may use the console application to indicate that all quote requests, or quote requests satisfying some set of parameters, be communicated to the dealer console, so that the dealer can customize or personalize a response to a given quote request. Accordingly, when a quote request is received at a dealer's console, the dealer can tailor a response by selecting information about one or more automobiles that are in current inventory, and including up-to-the-minute pricing information, dealer discounts, and so forth.

Accordingly, in response to the end-user's quote request, the end-user will receive via the mobile application various competing offers for an automobile that matches the end-user's specified parameters. With some embodiments, the responses to the quote requests are presented via the mobile application, without the end-user having to provide any personal information to any particular automobile dealer. If an end-user would like to accept an offer, the end-user can then provide personal information enabling the dealer to contact the end-user to conclude the transaction.

Consistent with embodiments of the present invention, by simply scanning a code on a sticker presented in a window of an automobile, an end-user is presented with multiple offers to buy an automobile that exactly matches the end-user specified parameters included in the quote request. Because the quote requests include geo-location data and are generated, at least in part, based on an end-user scanning a code from an actual sticker of an automobile on a dealer's lot with a mobile computing device, the participating automobile dealers can trust that the quotes are coming from customers in a preferred geographical region and with serious intent on making a purchase. Various other advantages are described below in connection with the description of the figures.

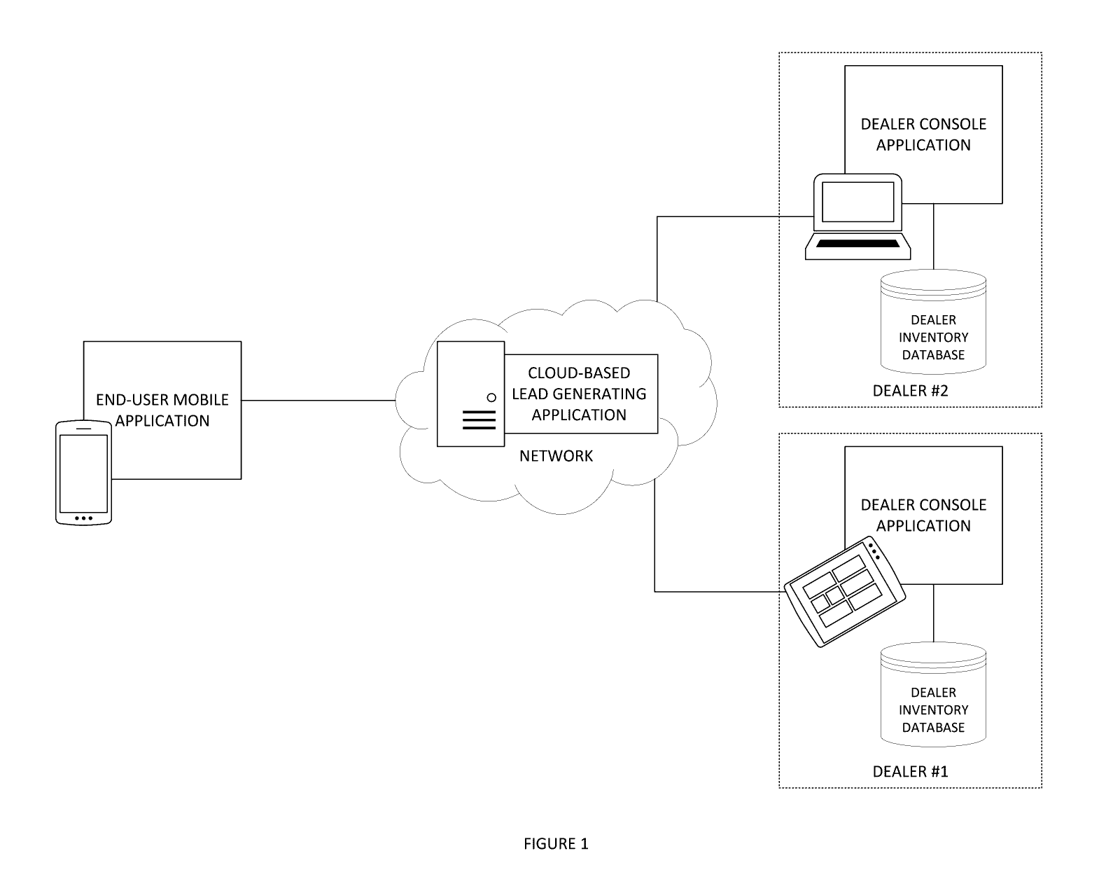

FIG. 1 is a computer networking environment in which some embodiments of the present invention might be deployed. As shown in FIG. 1, an end-user will access and interface with the cloud-based lead generating application using a mobile application. This mobile application may reside and execute on a mobile phone or tablet computing device, typically having a touch-screen interface along with one or more image sensing components (e.g., cameras). Additionally, the mobile computing device on which the mobile application resides will typically include location services via which the location of the mobile computing device can be obtained. For example, with some embodiments, location information can be obtained using an on-board global positioning system (GPS) device or component. Of course, other location based sensing devices and techniques might also be deployed.

Participating automobile dealers are provided with a dealer console application, which may reside and execute on any one of a mobile computing device (e.g., phone or tablet) a desktop computer, or similar computing devices. With some embodiments, each of several sales persons working at a dealership may have his or her own dealer console application. The dealer console application, which may be a native application or a web-based application, serves as the dealer's interface to the cloud-based lead generating application. Accordingly, using the dealer console application, the dealer can specify various configuration settings and parameters for use by the lead generating application. For example, a dealer may specify an automatic or manual response mode for quote requests. Accordingly, under the manual mode, all quote requests will be forwarded on to the dealer's console application, allowing the dealer to personalize or customise a response, for example, by selecting information relating to automobiles that are currently in inventory, and providing up-to-the-minute pricing information. In automatic response mode, the dealer may provide various parameters to define the required characteristics for determining the degree of a match between the information provided in a quote request and the dealer's current inventory. Using the provided parameters, the lead generating application will process incoming quote requests to determine the degree to which a dealer has inventory matching the quote request, and ultimately whether an automated response from a particular dealer is warranted. Accordingly, with some embodiments, the cloud-based lead generating application will have real-time access to a dealer's database of current inventory information.

When a dealer has opted for manual response mode, the dealer can use the dealer console application to select information relating to one or more automobiles in current inventory that best matches the information included with the quote request. With some embodiments, the quote request is automatically processed at the dealer console application to identify the best matching automobiles, which are then highlighted or suggested to the dealer as appropriate to include with the response. This minimizes the amount of inventory searching required by the dealer and makes it possible to generate responses very rapidly. In addition, the console application may provide pricing information for recent sales transactions of the same or similar automobiles, thereby providing the dealer with current pricing information.

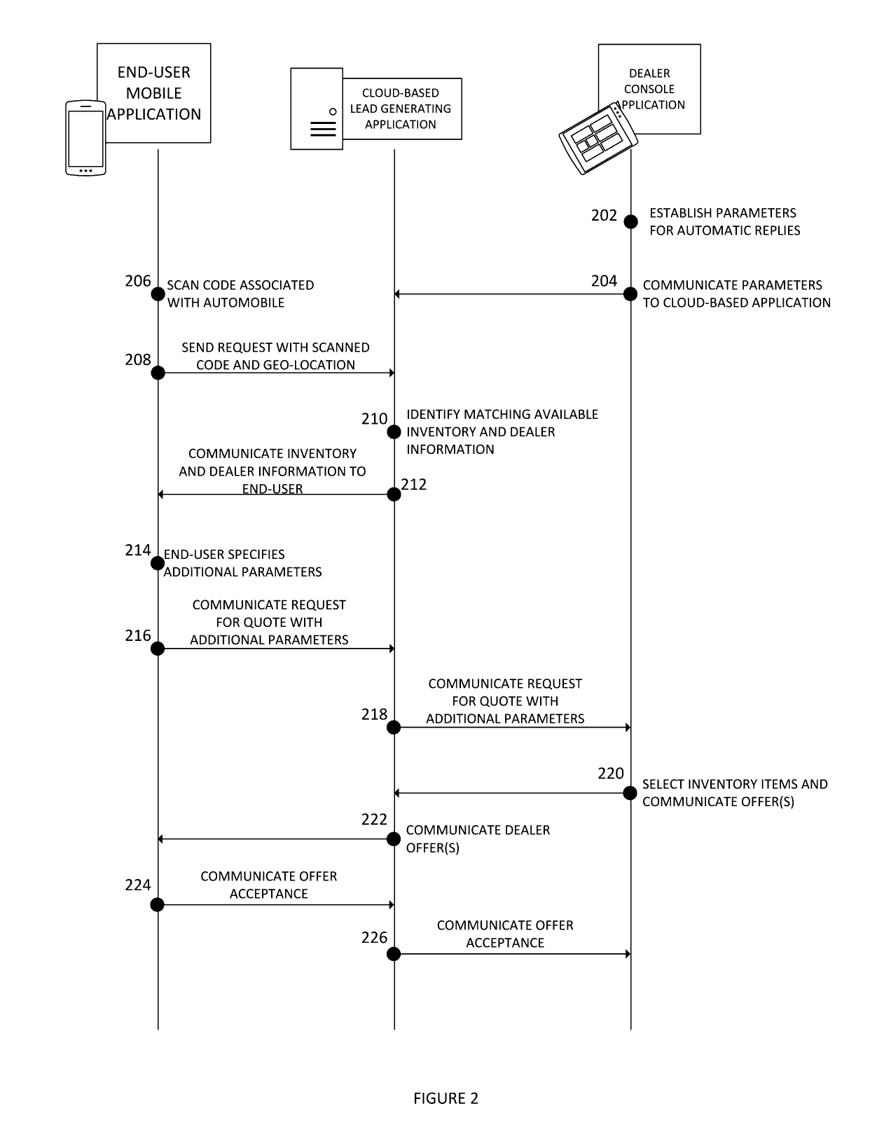

FIG. 2 is a multi-component flow diagram showing the various processing steps or operations performed by the various components, consistent with some embodiments. As shown in FIG. 2, at operation 202, via a dealer console application, a dealer establishes various parameters specifying the circumstances under which the lead generating application should provide automatic replies on behalf of the dealer. At operation 204, these parameters are communicated to the cloud-based lead generating application, where they are stored and then used in processing incoming end-user requests. For instance, a dealer may desire automatic replies when a particular request is received from an end-user in a certain geographic region. Similarly, a dealer may opt for automatic replies (or, manual replies) when an automobile in the dealer's current inventory matches (to a certain degree) the information provided in an end-user's request. As such, the determination of whether an automatic or manual reply is appropriate may be made based on the degree to which a dealer has an automobile in inventory that matches (completely or partially) the preferences of the end-user. As such, the parameters specified b the dealer can be used by the lead generating application to determine when an automatic reply is appropriate and preferred, and/or when a manual reply is appropriate and preferred.

At operation 206, an end-user uses his or her mobile application to scan a code or symbol presented in connection with an automobile. For example, the code may be some type of bar code, QR code, etc., presented on a sticker shown in a window of a new automobile located on a dealer's lot. Alternatively, with some embodiments, the code may be presented in a printed publication (e.g., a magazine, sales brochure, etc.). In yet another embodiment, the code or symbol may be an alphanumeric series that the end-user can input via a soft-keyboard presented on the touch screen of the mobile device.

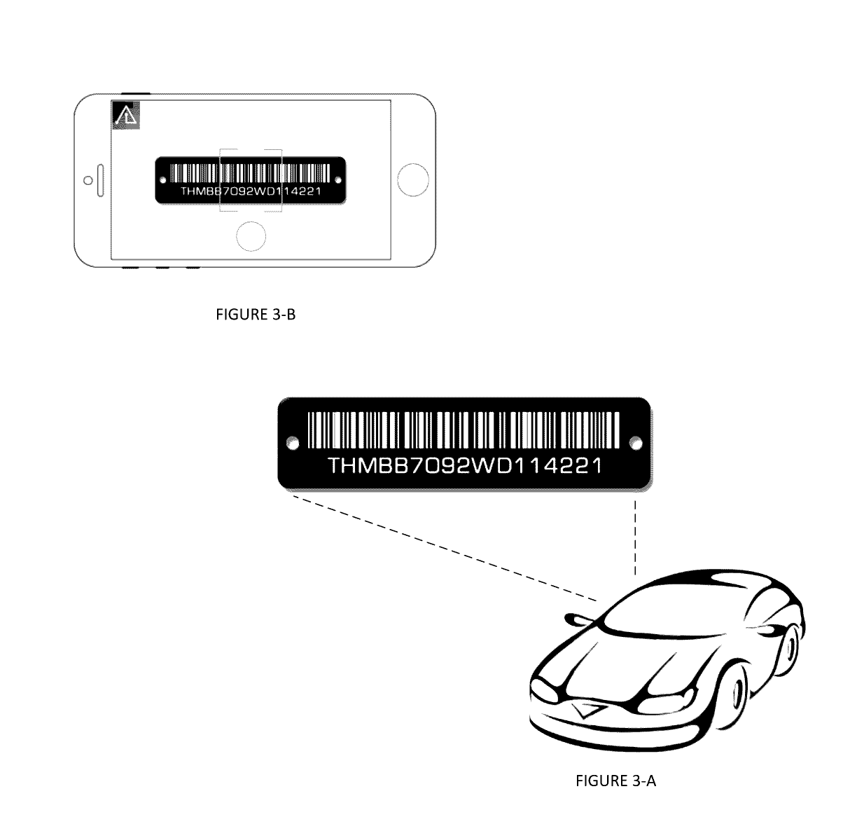

FIGS. 3A and 3B are diagrams illustrating an example of a user interface and providing an example of how an end-user scans a code associated with an automobile, using a mobile computing device, consistent with some embodiments of the invention. As illustrated in FIG. 3A, a bar code may be displayed in the sticker of a window of a new automobile at a dealer's automobile lot. As shown in FIG. 3B, by simply holding the mobile computing device up to the bar code, the bar code can be scanned with the camera or image sensor of the mobile computing device.

Referring again to FIG. 2, however the code is obtained, at operation 208, the code is communicated along with geo-location information identifying the end-user's current location to the cloud-based lead generating application. At operation 210, the cloud-based lead generating application receives the request and processes the request to identify and obtain information about the automobile from which the code was obtained, and various dealers who have automobiles in inventory that partially, or wholly, match the requested automobile. At operation 212 the automobile information as well as dealer and inventory information are communicated to the end-user's mobile application.

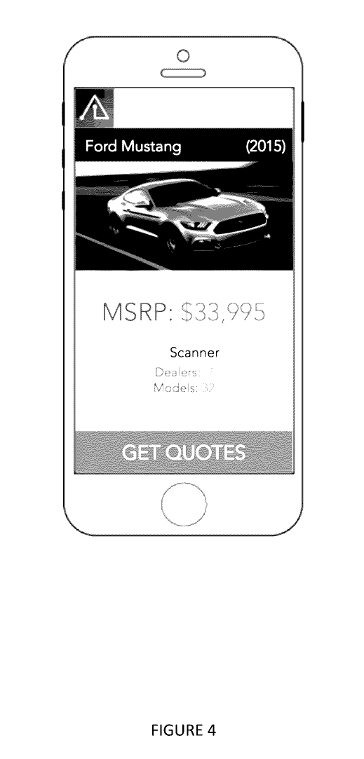

FIG. 4 illustrates an example user interface that may be presented in response to the end-user's initial request. For instance, as shown in FIG. 4, the user interface includes basic information about the automobile from which the code was obtained, such information including, but certainly not limited to: the make, model and year of the automobile, the trim level, the exterior and interior colors, the manufacturers suggested retail price (MSRP), the number of dealers having at least one automobile in stock that matches the requested automobile, and the total number of models in inventory.

With some embodiments, a dealer may specify that the dealer should be included in response to an end-user's request only when the request satisfies certain criteria. For example, some dealers may only be interested in requests that are generated with codes having been scanned from new automobiles in some predetermined geo-locations. Other dealers may only be interested in participating when a request specifies an automobile that is an exact match to one in that dealer's current inventory. Furthermore, the price that is ultimately charged to each dealer may vary based on various characteristics of the lead that is being generated, for example, such that the price for leads may vary based on their perceived strength, as inferred through various characteristics (e.g., the end-user's location, the source from which the code was scanned, the total number of requests generated by the end-user in a given time period, and so forth).

Referring again to FIG. 2, at operation 214, the end-user is provided an opportunity to specify various additional or alternative parameters for the desired automobile. For instance, if the end-user is interested in an exterior color different from the color of the automobile from which the code was scanned, the end-user can specify one or more alternative colors via the mobile application. Similarly, if a different trim level, engine size, and so forth, are desired, the end-user can specify such parameters before sending a quote request. In addition, the end-user may specify a preferred price, or, the dealer's price displayed on the sticker from which the code was scanned. In some instances, the end-user may identify a distance that he or she is willing to travel to make the automobile purchase. At operation 216, after specifying the various additional or alternative parameters, the end-user selects one or more dealers to whom a quote request is to be communicated. Finally, at operation 216, the quote request including any end-user specified parameters is communicated to the cloud-based lead generating application.

At operation 218, after receiving the quote request, the quote request is processed to determine whether an automatic reply should be generated on behalf of certain end-user selected dealers, and/or whether the quote request should be forwarded to the dealer console applications of one or more end-user selected dealers. For instance, based on the end-user specified parameters, various dealers may or may not have inventory satisfying the end-users' quote request. Similarly, one or more dealers may not be located within the geographical area specified by the end-user. Accordingly, the request is processed to determine the various dealers by which the request is to be appropriately handled, and then forwarded to the dealer console application of those dealers. At operation 220, a dealer console application receives the end-user's quote request and does some preliminary processing of the request to identify relevant inventory and sales information. This information is then presented to the dealer via the dealer console application, so as to allow the dealer to customize the information included in a quote that will be presented to the end-user.

At operation 222, responsive to the quote request, a dealer offer is received from a dealer console application and is forwarded on to the end-user's mobile application, where it is presented to the end-user. With some embodiments, when dealer offers are received at the lead generating application, one or more mobile notifications may be communicated to the end-user's mobile application, thereby notifying the end-user of the newly received dealer offers.

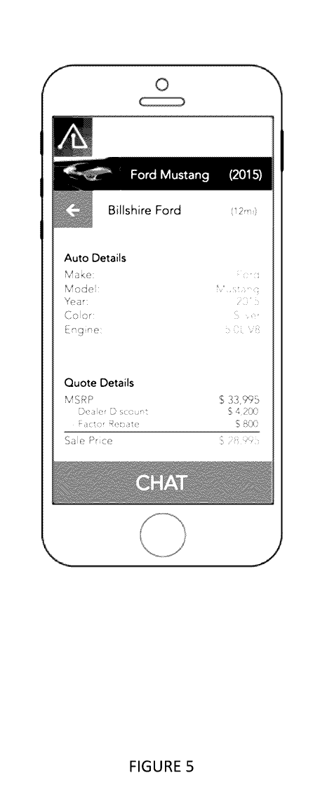

FIG. 5 illustrates an example user interface of a dealer offer, as presented at the end-user's mobile application. As shown in FIG. 5, the dealer offer may provide details about the exact car being offered, as well as detailed pricing information.

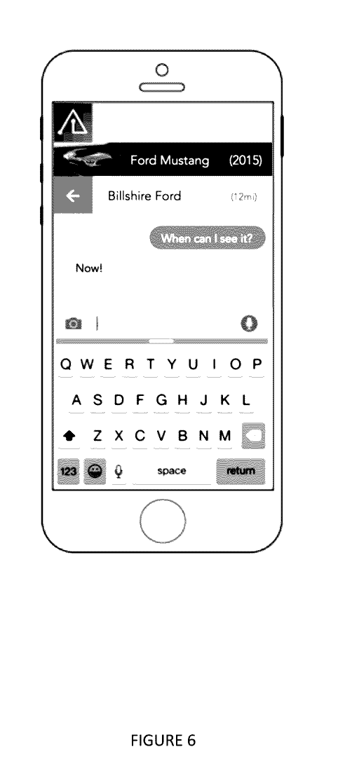

With some embodiments, the end-user may be presented with the option to directly contact the dealer in real-time, for example, through a chat interface, or alternatively, through video call interface. For example, in the user interface of FIG. 5, a “chat” button is shown. By pressing the “chat” button, the end-user can initiate a chat dialogue with the dealer—an example of which is presented in FIG. 6.

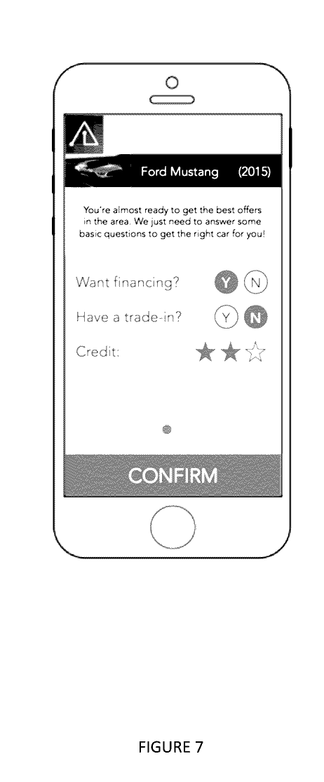

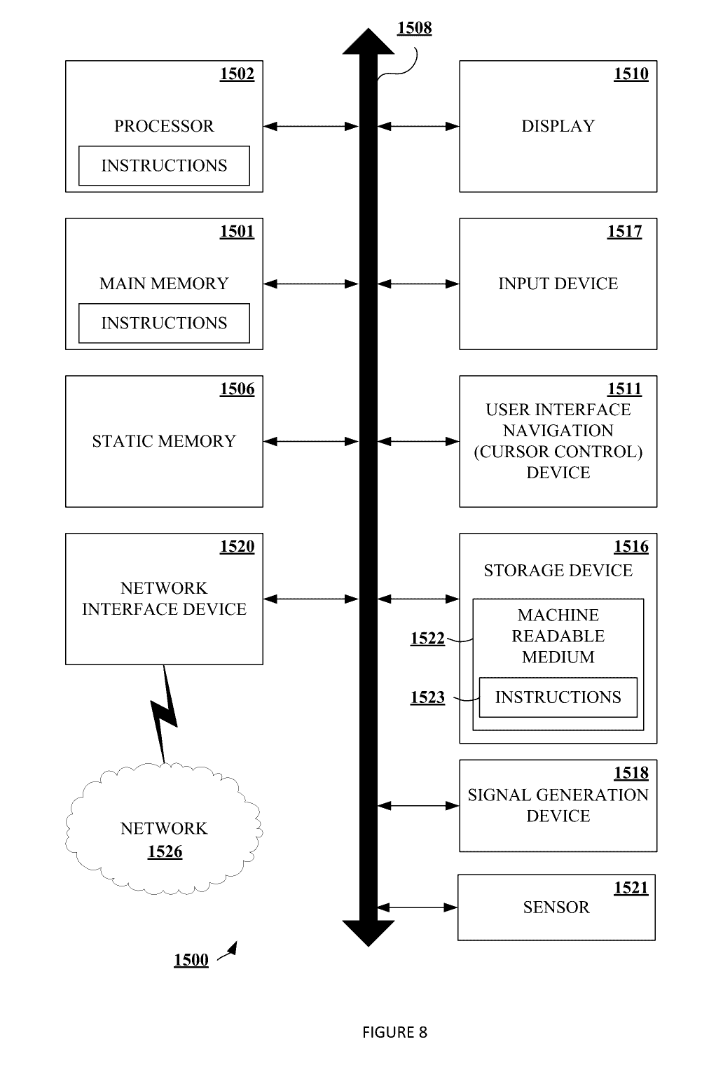

Referring again to FIG. 2, after reviewing all offers from all dealers, an end-user selects a particular offer of interest, and includes additional information (e.g., trade-in information, financing information, etc.) to communicate to the selected dealer, as indicated at operation 224, and illustrated in the example user interface of FIG. 7.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

FIG. 5 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. ho a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and remove disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure, This Detailed Description, therefore, is not to be taken in a limiting sense, and the scope of various embodiments is defined only by the appended claims, along with the full range of equivalents to which such claims are entitled.

We claim:

1. A mobile computing system comprising:
a processor for executing instructions;
an image sensor;
a location sensing component; and
executable instructions, which, when executed by the processer, cause the mobile computer system to:
responsive to detecting user-input, i) obtain via the image sensor an image of a code affixed to an automobile, and ii) generate geolocation information representing the current location of the mobile computing system; and
generate, and then communicate over a wireless network to a server, a query including the code, or a translation of the code, and the geolocation information;
receive from the server information relating to the automobile from which the image of the printed code was obtained and information identifying at least one automobile dealer who has in inventory an automobile that matches characteristics of the automobile from which the image of the printed code was obtained.
